(19) United States
(12) Patent Application Publication
(10) Pub. No.: US 2017/0305398 A1
(43) Pub. Date: Oct. 26, 2017

(54) BRAKE ASSISTANT CONTROL SYSTEM AND METHOD THEREOF

(71) Applicant: HON HAI PRECISION INDUSTRY CO., LTD., New Taipei (TW)

(72) Inventor: CHUNG-NAN KO, New Taipei (TW)

(21) Appl. No.: 15/135,568

(22) Filed: Apr. 22, 2016

(51) Int. Cl. B60T 8/32; B60T 17/18; B60T 7/12

(52) U.S. Cl. CPC B60T 8/3205; B60T 7/12; B60T 17/18

(57) ABSTRACT

A brake assistant control system for a vehicle includes one or more sensors, to detect a movement state of the vehicle. The one or more sensor includes a g-sensor to detect acceleration of a movement of the vehicle, a braking force control unit to adjust a braking force of the vehicle, and a brake assistant control module. The brake assistant control module is coupled to all the sensors and can receive signals from all the sensors. When the motion sensor detects the vehicle is in a stationary state and the g-sensor detects acceleration of the vehicle, the brake assistant control module can increase braking force to slow the speed of the vehicle, through the braking force control unit.

### FIELD

The subject matter herein generally relates to vehicle safety including a brake assistant control system, and a brake assistant control method.

### BACKGROUND

Driving a vehicle requires that the driver have an understanding of a vehicle braking operation. The driver must understand the force that is to be applied to a break pedal to sufficiently slow the vehicle. Additionally, the driver must watch out for a sign (vehicle, intersection, light, or other road hazard) to apply the brakes. An additional factor that driver must consider is distance.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a block view of a brake assistant control system in at least one embodiment.

FIG. 2 is a flowchart of a brake assistant control method in a first embodiment.

FIG. 3 is a flowchart of a brake assistant control method in a second embodiment.

FIG. 4 is a flowchart of a brake assistant control method in a third embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the configurations described herein. However, it will be understood by those of ordinary skill in the art that the configurations described herein can be practiced without these specific details. In other instances, methods, procedures, and components have not been described in detail so as not to obscure the related relevant feature being described. Also, the description is not to be considered as limiting the scope of the configurations described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

A brake assistant control system for utilization in a vehicle to assist a driver in critical situations and adjust braking force to avoid crashes. The vehicle as described in the examples below is a car. In the following description, the methods and devices can be applied to other vehicles including but not limited to other road vehicles, trucks, or buses.

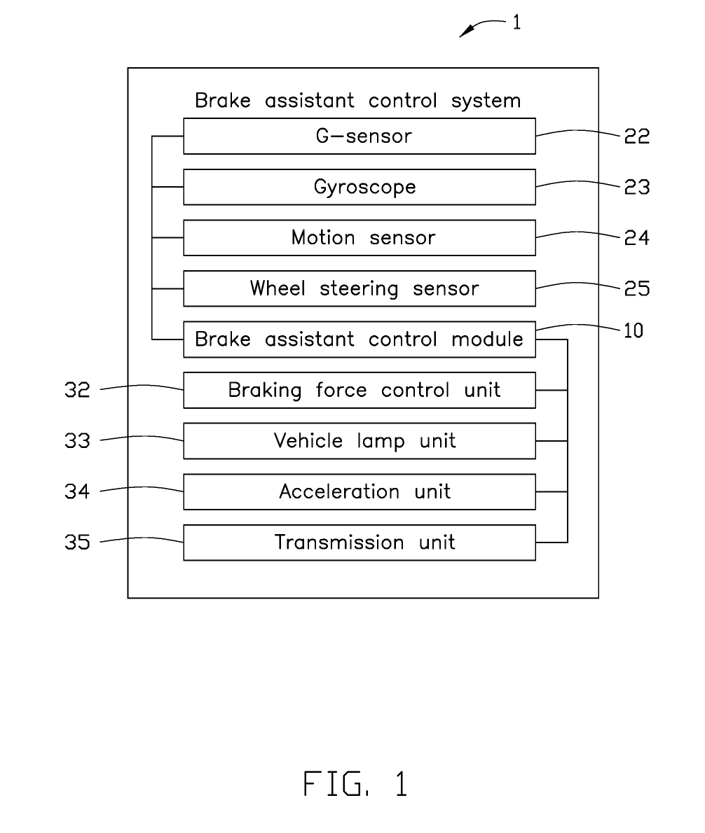

FIG. 1 illustrates a block view of a brake assistant control system in at least one embodiment. A brake assistant control system 1 includes a brake assistant control module 10. The brake assistant control module 10 can be a control box including at least one processor. The brake assistant control can be coupled to a plurality of sensors. The plurality of sensors can include a gravity sensor (g-sensor) 22, a gyroscope 23, a motion sensor 24, and a wheel steering sensor 25, but is not limited to such sensors.

In at least one embodiment, the g-sensor 22 can be an accelerometer, which can be a device that measures acceleration. The g-sensor 22 can be mounted in a body of the vehicle, (for example, in a head portion of vehicle). The g-sensor 22 can be used to measure vibration on vehicles and can also be used to measure inclination, dynamic distances, and speeds, with or without the influence of gravity.

In at least one embodiment, the gyroscope 23 can calculate orientation and the turnings of the vehicle. The integration of the gyroscope 23 is allowed for more accurate recognition of movement within a 3D space than the g-sensor 22. The gyroscope 23 can be mounted in the body of the vehicle. The gyroscope 23 can be combined with the g-sensor 22 for more accurate direction and motion-sensing.

In at least one embodiment, the motion sensor 24 can be a speedometer measuring a state or an instant speed of a vehicle. The motion sensor 24 can be mounted to the body of the vehicle.

In at least one embodiment, the wheel steering sensor 25 can be a rotary sensor, which can measure rotation and speed of rotation of road wheel, steering angle of wheel, and so on. The wheel steering sensor 25 can include at least two wheel steering sub-sensors which can mounted on opposite wheels of the vehicle.

In at least one embodiment, the sensors coupled to the brake assistant control module 10 can determine yaw rate, speed, acceleration, roll rate, steering angle, longitudinal acceleration, and a pitch rate sensor. The sensors described are exemplary only and other suitable sensors may be used. Further, any suitable combination of type, amount, and location may be used. The sensors described can be incorporated into a single module.

The brake assistant control module 10 can be also coupled to a braking force control unit 32, a vehicle lamp unit 33, an acceleration unit 34, and a transmission unit 35.

In at least one embodiment, the braking force control unit 32 can be coupled to a brake pedal to control force transmitted by the brake panel. The braking force control unit 32 can increase or reduce braking force applied by a driver to the vehicle.

In at least one embodiment, the vehicle lamp unit 33 can be at least one of a tail lamp, a rear position lamp, and side turn lamps.

The acceleration unit 34 can be coupled to an accelerator pedal to accelerate the vehicle.

The transmission unit 35 can be a gearbox that uses gears and/or gear trains to convert and transmit the speed and torque of a rotating power source to another device in the vehicle. The transmission unit 35 can control the vehicle from driving mode to a parking mode or a neutral mode.

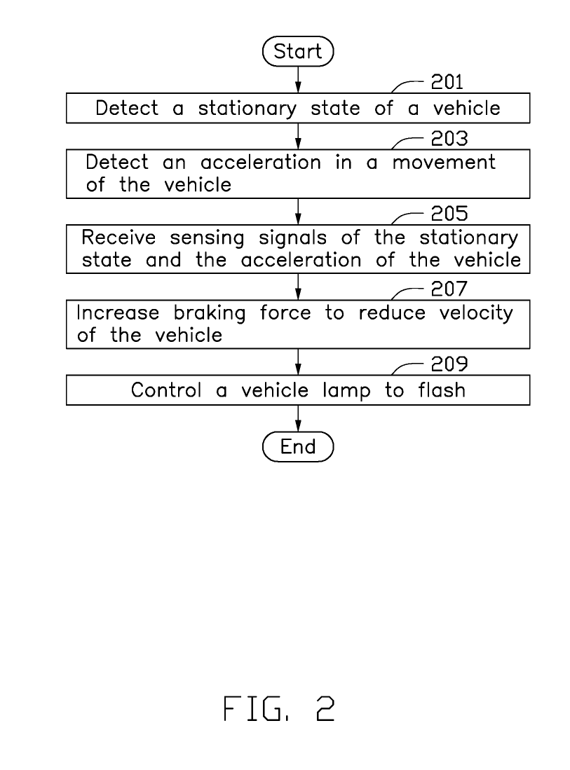

FIG. 2 illustrates a brake assistant control method in a first embodiment. The example method is provided by way of example, as there are a variety of ways to carry out the method. The brake assistant control method described below can be carried out using the configurations illustrated in FIG. 2, for example, and various elements of these figures are referenced in explaining the example method. Each block shown in FIG. 2 represents one or more processes, methods, or subroutines, carried out in the example method. The order of blocks is illustrative only and the order of the blocks can change. Additional blocks can be added or fewer blocks can be utilized without departing from this disclosure. The example method can begin at block 201. The brake assistant control method includes the following blocks.

At block 201, detect a stationary state of a vehicle by a motion sensor.

At block 203, detect an acceleration of the vehicle by a g-sensor.

At block 205, receive sensing signals of the movement and the acceleration therein by a brake assistant control module.

At block 207, increase braking force automatically by the brake assistant control module to reduce velocity of the vehicle without pressing the brake pedal by the driver.

At block 209, in an alternative embodiment, control a vehicle lamp to flash by the brake assistant control module.

In the first embodiment, a gyroscope can further provided to detect an inclined state of the vehicle. When the vehicle is in an inclined state, and an inclined angle is greater than a predetermined angle when the vehicle is moving other than in an expected direction, the brake assistant control module can increase braking force to brake the vehicle. For example, a car is driven up to a slope, the brake assistant control method can prevent the car from gliding backward intellectually when the car is started up on the slope.

In the first embodiment, the gyroscope can also detect an inclined state of the vehicle. A wheel steering sensor can detect rotation speeds of two wheels of the vehicle at opposite sides. When the vehicle is in an inclined state, and an inclined angle is greater than a predetermined angle when the respective wheel rotation speeds of two opposing wheels are not equal, the brake assistant control module can increase braking force to brake the vehicle.

In the first embodiment, when the motion sensor detects that the vehicle is stationary and the g-sensor detects acceleration of movement of the vehicle simultaneously, the brake assistant control module can deactivate an acceleration unit to prevent the vehicle from being accelerated.

In the first embodiment, when the brake assistant control module increases braking force to reduce velocity of the vehicle through the braking force control unit, and the vehicle is in the driving mode, the brake assistant control module can shift a driving mode to a parking mode or to a neutral mode.

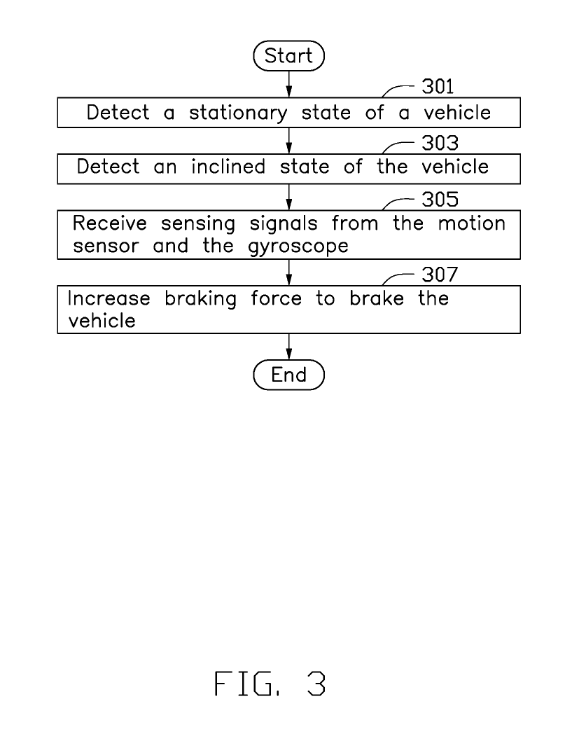

FIG. 3 illustrates a brake assistant control method in a second embodiment. The example method is provided by way of example, as there are a variety of ways to carry out the method. The brake assistant control method described below can be carried out using the configurations illustrated in FIG. 3, for example, and various elements of these figures are referenced in explaining the example method. Each block shown in FIG. 3 represents one or more processes, methods or subroutines, carried out in the example method. The order of blocks is illustrative only and the order of the blocks can change. Additional blocks can be added or fewer blocks can be utilized without departing from this disclosure. The example method can begin at block 301. The brake assistant control method includes the following blocks.

At block 301, detect a stationary state of a vehicle by a motion sensor.

At block 303, detect an inclined state of the vehicle by a gyroscope.

At block 305, receive sensing signals from the motion sensor and the gyroscope by a brake assistant control module.

At block 307, when the vehicle is in an inclined state, and an inclined angle is greater than a predetermined angle and the vehicle is moving other than in an expected direction, the brake assistant control module can increase braking force to brake the vehicle, through the brake force control unit.

In the second embodiment, a g-sensor is coupled to brake assistant control module to detect acceleration of a movement of the vehicle. When the motion sensor detects that the vehicle is in a stationary state and the g-sensor detects acceleration of the vehicle, the brake assistant control module can increase braking force to reduce velocity of the vehicle, through the brake force control unit.

In the second embodiment, a vehicle lamp can be coupled to the brake assistant control module. When the motion sensor detects that the vehicle is in the stationary state and the g-sensor detects acceleration of the vehicle, the brake assistant control module can control the vehicle lamp to flash. An acceleration unit can be coupled to the brake assistant control module to enable acceleration of the vehicle. When the motion sensor detects that the vehicle is in the stationary state and the g-sensor detects acceleration of a change in speed of the vehicle, the brake assistant control module can deactivate the acceleration unit.

In the second embodiment, a wheel steering sensor can be coupled to the brake assistant control module to detect wheels rotation and speeds of rotation of wheels of the vehicle at opposite sides. When the vehicle is in an inclined state, and an inclined angle is greater than a predetermined angle and the rotation speeds of two opposing wheels of the vehicle are not equal, the brake assistant control module can increase braking force to brake the vehicle through the brake force control unit.

In the second embodiment, a transmission unit can control a steering mode of the vehicle. When the brake assistant control module increases braking force to slow the vehicle through the brake force control unit, and the vehicle is in a driving mode, the brake assistant control module can adjust the transmission unit to shift the driving mode to a parking mode or to a neutral mode.

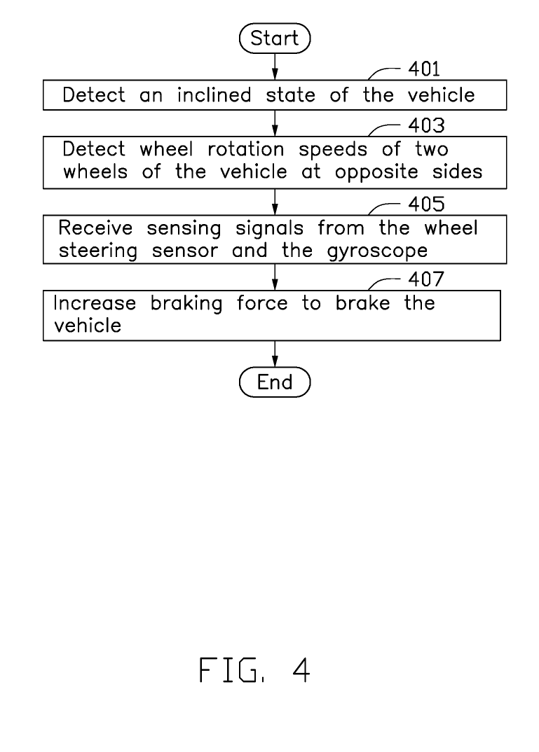

FIG. 4 illustrates a brake assistant control method in a third embodiment. The example method is provided by way of example, as there are a variety of ways to carry out the method. The brake assistant control method described below can be carried out using the configurations illustrated in FIG. 4, for example, and various elements of these figures are referenced in explaining the example method. Each block shown in FIG. 4 represents one or more processes, methods or subroutines, carried out in the example method. Furthermore, the order of blocks is illustrative only and the order of the blocks can change. Additional blocks can be added or fewer blocks can be utilized without departing from this disclosure. The example method can begin at block 401. The brake assistant control method includes the following blocks.

At block 401, detect an inclined state of the vehicle by a gyroscope.

At block 403, detect wheel rotation speeds of opposing wheels of the vehicle by one or more a wheel steering sensors.

At block 405, receive sensing signals from the wheel steering sensors and the gyroscope by a brake assistant control module.

At block 407, when the vehicle is in an inclined state, and an inclined angle is greater than a predetermined angle and the respective wheel rotation speeds of two opposing wheels are not equal, the brake assistant control module can increase braking force to brake the vehicle, through the brake force control unit.

The configurations shown and described above are only examples. Many details are often found in the art such as the other features of a brake assistant control system and method. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the configurations described above may be modified within the scope of the claims.

What is claimed is:

1. A brake assistant control system for a vehicle comprising:
a motion sensor configured to detect a stationary state of the vehicle;
a g-sensor configured to detect an acceleration of the vehicle;
a braking force control unit configured to automatically adjust a braking force of the vehicle; and
a brake assistant control module coupled to the motion sensor, the g-sensor, and the braking force control unit, and configured to receive sensing signals from the motion sensor and the g-sensor,
wherein when the motion sensor detects the vehicle is in the stationary state and the g-sensor detects the acceleration of the vehicle, the brake assistant control module is configured to increase braking force to reduce velocity of the vehicle through the braking force control unit.

2. The brake assistant control system of claim 1, further comprising a vehicle lamp coupled to the brake assistant control module, wherein when the motion sensor detects the vehicle is in the stationary state and the g-sensor detects the acceleration in the movement of the vehicle, the brake assistant control module is configured to control the vehicle lamp to flash.

3. The brake assistant control system of claim 1, further comprising a gyroscope coupled to the brake assistant control module to detect an inclined state of the vehicle, wherein when the vehicle is in the inclined state, and an inclined angle is greater than a predetermined angle when the vehicle is moving other than an expected direction, the brake assistant control module is configured to increase braking force to brake the vehicle through the braking force control unit.

4. The brake assistant control system of claim 1, further comprising a gyroscope coupled to the brake assistant control module to detect an inclined state of the vehicle, and a wheel steering sensor coupled to the brake assistant control module to detect wheel rotation speeds of two wheels of the vehicle at opposite sides, wherein when the vehicle is in the inclined state, and an inclined angle is greater than a predetermined angle when the wheel rotation speeds of two wheels of the vehicle at opposite sides are not equal, the brake assistant control module is configured to increase braking force to brake the vehicle through the braking force control unit.

5. The brake assistant control system of claim 1, further comprising an acceleration unit coupled to the brake assistant control module configured to accelerate the vehicle, wherein when the motion sensor detects the vehicle is in the stationary state and the g-sensor detects the acceleration of the movement of the vehicle, the brake assistant control module is configured to deactivate the acceleration unit.

6. The brake assistant control system of claim 1, further comprising a transmission unit to control a steering mode of the vehicle, wherein when the brake assistant control module increases braking force to reduce velocity of the vehicle through the braking force control unit, and the vehicle is in a driving mode, the brake assistant control module adjust the transmission unit to shift the driving mode to a parking mode or to a neutral mode.

7. A brake assistant control method for a vehicle comprising:
detecting a stationary state of the vehicle by a motion sensor;
detecting an acceleration of the vehicle by a g-sensor;
receiving sensing signals of the stationary state and the acceleration by a brake assistant control module; and
increasing braking force to reduce velocity of the vehicle by the brake assistant control module.

8. The brake assistant control method of claim 7, further comprising controlling a vehicle lamp of the vehicle to flash.

9. The brake assistant control method of claim 7, further comprising:
detecting an inclined state of the vehicle by a gyroscope; and
increasing braking force to brake the vehicle when the vehicle is in the inclined state, and an inclined angle is greater than a predetermined angle when the vehicle is moving other than an expected direction.

10. The brake assistant control method of claim 7, further comprising:
detecting an inclined state of the vehicle by a gyroscope;
detecting wheel rotation speeds of two wheels of the vehicle at opposite sides by a wheel steering sensor; and
increasing braking force to brake the vehicle when the vehicle is in the inclined state, and an inclined angle is greater than a predetermined angle when the wheel rotation speeds of two wheels of the vehicle at opposite sides are not equal.

11. The brake assistant control method of claim 7, further comprising:
deactivate an acceleration unit to prevent the vehicle from being accelerated when the motion sensor detects the vehicle is in the stationary state and the g-sensor detects the acceleration of the vehicle.

12. The brake assistant control method of claim 7, further comprising shifting a driving mode to a parking mode or a neutral mode when the brake assistant control module increases braking force to reduce velocity of the vehicle through the braking force control unit, and the vehicle is in the driving mode.

13. A brake assistant control system for a vehicle comprising:
a motion sensor configured to detect a movement state of the vehicle;
a gyroscope configured to detect an inclined state of the vehicle,
a braking force control unit configured to adjust a braking force of the vehicle; and
a brake assistant control module coupled to the motion sensor, the gyroscope, and the braking force control unit, and configured to receive sensing signals from the motion sensor and the gyroscope,
wherein when the vehicle is in an inclined state, an inclined angle is greater than a predetermined angle and when the vehicle is moving other than an expected direction, the brake assistant control module is configured to increase braking force to brake the vehicle through the braking force control unit.

14. The brake assistant control system of claim 13, further comprising a g-sensor coupled to brake assistant control module to detect an acceleration of a movement of the vehicle, wherein when the motion sensor detects the vehicle is in a stationary state and the g-sensor detects the acceleration of the vehicle, the brake assistant control module is configured to increase braking force to reduce velocity of the vehicle through the braking force control unit.

15. The brake assistant control system of claim 14, further comprising a vehicle lamp coupled to the brake assistant control module, wherein when the motion sensor detects the vehicle is in the stationary state and the g-sensor detects the acceleration of the vehicle, the brake assistant control module is configured to control the vehicle lamp of the vehicle to flash.

16. The brake assistant control system of claim 14, further comprising an acceleration unit coupled to the brake assistant control module configured to accelerate the vehicle, wherein when the motion sensor detects the vehicle is in the stationary state and the g-sensor detects the acceleration of the vehicle, the brake assistant control module is configured to deactivate the acceleration unit.

17. The brake assistant control system of claim 13, further comprising a wheel steering sensor coupled to the brake assistant control module to detect wheel rotation speeds of two wheels of the vehicle at opposite sides, wherein when the vehicle is in the inclined state, and an inclined angle is greater than a predetermined angle and when respective wheel rotation speeds of two opposing wheels of the vehicle at opposite sides are not equal, the brake assistant control module is configured to increase braking force to brake the vehicle through the braking force control unit.

18. The brake assistant control system of claim 13, further comprising a transmission unit to control a steering mode of the vehicle, wherein when the brake assistant control module increases braking force to reduce velocity of the vehicle through the braking force control unit, and the vehicle is in a driving mode, the brake assistant control module adjusts the transmission unit to shift the driving mode to a parking mode or to a neutral mode.
